(19) United States
(12) Patent Application Publication
(10) Pub. No.: US 2024/0078830 A1
(43) Pub. Date: Mar. 7, 2024

(54) IMAGE PROCESSING APPARATUS AND IMAGE PROCESSING METHOD

(71) Applicant: CANON KABUSHIKI KAISHA, Tokyo (JP)

(72) Inventor: Yuta Kawamura, Kanagawa (JP)

(21) Appl. No.: 18/459,614

(22) Filed: Sep. 1, 2023

(30) Foreign Application Priority Data
Sep. 6, 2022 (JP) 2022-141519

(51) Int. Cl. G06V 40/10; G06T 7/246; G06V 10/82

(52) U.S. Cl. CPC G06V 40/10; G06T 7/248; G06V 10/82; G06T 2207/20081; G06T 2207/20084; G06T 2207/30196

(57) ABSTRACT

An image processing apparatus directed to accurately associate a plurality of different parts belonging to the same subject is disclosed. The image processing apparatus detects a first part and a second part of a specific subject from an image and estimates a movement direction of the specific subject. The image processing apparatus then associates parts of the same subject among the first part and the second part that are detected, based on the estimated movement direction.

### BACKGROUND OF THE INVENTION

### Field of the Invention

The present invention relates to an image processing apparatus and an image processing method, and particularly relates to a technique for detecting a subject.

### Description of the Related Art

A technique for detecting an area in which a specific subject appears (a subject area) from an image, using machine learning is known (Japanese Patent Laid-Open No. 2021-152578). In Japanese Patent Laid-Open No. 2021-152578, when tracking a part of the specific subject, the whole of the specific subject and the part are detected individually. Then, to increase the tracking accuracy, whether the detection results belong to the same subject is determined based on a relationship between the detection positions of the whole and the part.

The method described in Japanese Patent Laid-Open No. 2021-152578 assumes that the part is within the whole of the detected specific subject. Accordingly, whether the whole and the part belong to the same subject cannot be determined based solely on the detection result for the part.

### SUMMARY OF THE INVENTION

The present invention has been conceived in light of these problems with conventional techniques. The present invention in one aspect provides an image processing apparatus and an image processing method capable of accurately associating a plurality of different parts belonging to the same subject.

According to an aspect of the present invention, there is provided an image processing apparatus comprising: one or more processors that execute a program stored in a memory and thereby function as: a detection unit that detects a first part and a second part of a specific subject from an image; an estimation unit that estimates a movement direction of the specific subject; and an association unit that, based on the estimated movement direction, associates parts of the same subject, among the first part and the second part detected by the detection unit.

According to another aspect of the present invention, there is provided an image processing apparatus comprising: one or more processors that execute a program stored in a memory and thereby function as: a detection unit that detects a first part and a second part of a specific subject from an image, wherein a detection result for the first part includes vectors indicating a position where a corresponding second part is highly probable to be present; and an association unit that associates parts of the same subject, among the first part and the second part detected by the detection unit, based on the vectors.

According to a further aspect of the present invention, there is provided an image processing method executed by an image processing apparatus, the image processing method comprising: detecting a first part and a second part of a specific subject from an image; estimating a movement direction of the specific subject; and based on the estimated movement direction, associating parts of the same subject, among the first part and the second part detected in the detecting.

According to another aspect of the present invention, there is provided an image processing method executed by an image processing apparatus, the image processing method comprising: detecting a first part and a second part of a specific subject from an image, wherein a detection result for the first part includes vectors indicating a position where a corresponding second part is highly probable to be present; and associating parts of the same subject, among the first part and the second part detected in the detecting, based on the vectors.

According to a further aspect of the present invention, there is provided a non-transitory computer-readable medium that stores a program, which when executed by a computer, causes the computer to function as an image processing apparatus comprising: a detection unit that detects a first part and a second part of a specific subject from an image; an estimation unit that estimates a movement direction of the specific subject; and an association unit that, based on the estimated movement direction, associates parts of the same subject, among the first part and the second part detected by the detection unit.

According to another aspect of the present invention, there is provided a non-transitory computer-readable medium that stores a program, which when executed by a computer, causes the computer to function as an image processing apparatus comprising: a detection unit that detects a first part and a second part of a specific subject from an image, wherein a detection result for the first part includes vectors indicating a position where a corresponding second part is highly probable to be present; and an association unit that associates parts of the same subject, among the first part and the second part detected by the detection unit, based on the vectors.

Further features of the present invention will become apparent from the following description of exemplary embodiments (with reference to the attached drawings).

### BRIEF DESCRIPTION OF THE DRAWINGS

FIG. 1 is a block diagram illustrating an example of the functional configuration of an image capturing apparatus serving as an example of an image processing apparatus according to embodiments.

FIG. 2 is a block diagram illustrating an example of the functional configuration of a subject detection unit according to first and third embodiments.

FIG. 3 is a diagram illustrating an example of a priority subject setting screen presented by the image capturing apparatus.

FIG. 4 is a flowchart illustrating subject detection processing according to the first embodiment.

FIGS. 5A and 5B are diagrams illustrating an example of dictionary data switching operations.

FIG. 6 is a flowchart illustrating movement direction estimation processing according to embodiments.

FIGS. 7A and 7B are diagrams schematically illustrating a part association method according to the first embodiment.

FIG. 8 is a block diagram illustrating an example of the functional configuration of a subject detection unit according to a second embodiment.

FIG. 9 is a flowchart illustrating subject detection processing according to the second embodiment.

FIG. 10 is a diagram schematically illustrating a part association method according to the second embodiment.

FIG. 11 is a flowchart illustrating subject detection processing according to the third embodiment.

FIG. 12 is a diagram schematically illustrating a part association method according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following embodiments will describe a case where the present invention is applied in an image capturing apparatus such as a digital camera. However, an image capturing function is not essential to the present invention, and the present invention can be implemented in any electronic device. Examples of such an electronic device include video cameras, computer devices (personal computers, tablet computers, media players, PDAs, and the like), mobile phones, smartphones, game consoles, robots, drones, and dashboard cameras. These are merely examples, however, and the present invention can be applied in other electronic devices as well.

Configuration of Image Capturing Apparatus

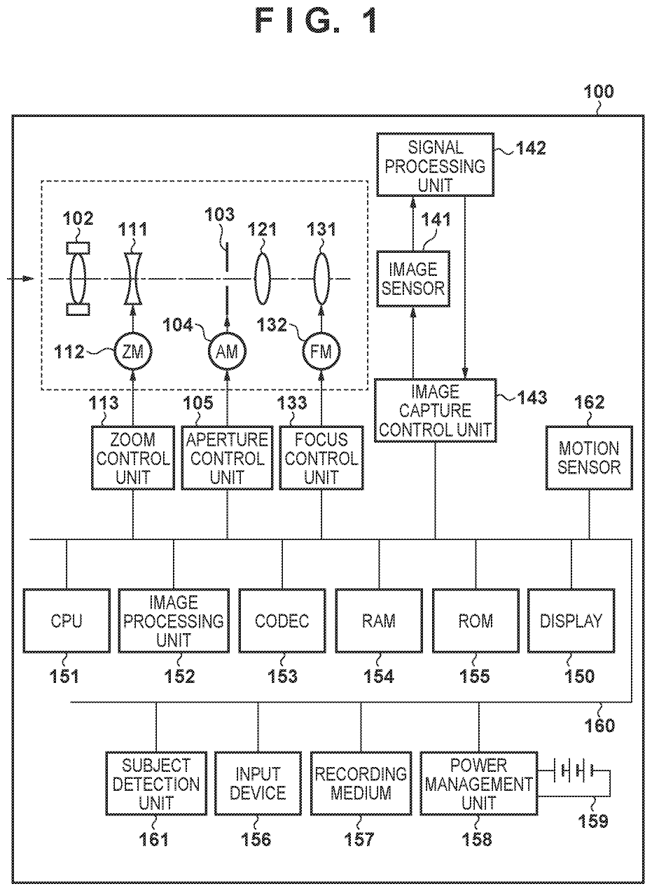

FIG. 1 is a block diagram illustrating an example of the functional configuration of an image capturing apparatus 100 according to embodiments. The image capturing apparatus 100 is capable of shooting and recording moving images and still images. The function blocks of the image capturing apparatus 100 are communicatively connected to each other by a bus 160. Operations of the image capturing apparatus 100 are realized by a main control unit (CPU) 151 loading programs stored in a ROM 155 into a RAM 154 and executing the programs to control each function block.

In the drawings, function blocks having a name ending in “unit” may be implemented by dedicated hardware such as an ASIC. Alternatively, the function blocks may be realized by a processor such as a CPU executing programs stored in the memory. Note also that multiple function blocks may be implemented by a shared configuration (e.g., a single ASIC). Furthermore, hardware implementing some functions of a given function block may be included in hardware implementing another function block.

A subject detection unit 161 detects areas of at least two parts of a subject for detection (a specific subject). For example, if the specific subject is a human or animal, the subject detection unit 161 detects a face area and a trunk area. Additionally, the subject detection unit 161 associates parts, among the detected parts, which are determined to belong to the same subject. The configuration and operations of the subject detection unit 161 will be described in detail later.

A shooting lens (lens unit) 101 includes a fixed 1-group lens 102, a zoom lens 111, an aperture stop 103, a fixed 3-group lens 121, a focus lens 131, a zoom motor 112, an aperture motor 104, and a focus motor 132. The fixed 1-group lens 102, the zoom lens 111, the aperture stop 103, the fixed 3-group lens 121, and the focus lens 131 constitute an optical imaging system. Although each lens is illustrated as being a single lens for the sake of convenience, each lens may be constituted by a plurality of lenses. Additionally, the shooting lens 101 may be configured as a detachable lens unit. The aperture stop 103 may also have a mechanical shutter function.

An aperture control unit 105 controls operations of the aperture motor 104, which drives the aperture stop 103, to change the aperture diameter of the aperture stop 103. A zoom control unit 113 controls operations of the zoom motor 112, which drives the zoom lens 111, to change the focal length (angle of view) of the shooting lens 101.

A focus control unit 133 performs automatic focus detection (AF) using the image plane phase detection method. In other words, the focus control unit 133 calculates a defocus amount and a defocus direction of the shooting lens 101 based on a phase difference between a pair of focus detection signals (an A image and a B image) obtained from an image sensor 141. The focus control unit 133 then converts the defocus amount and the defocus direction into a driving amount and a driving direction of the focus motor 132. The focus control unit 133 controls the operations of the focus motor 132 based on the driving amount and the driving direction, and by driving the focus lens 131, controls the focus state of the shooting lens 101.

The focus control unit 133 may calculate the defocus amount and the defocus direction of the shooting lens 101 based on a phase difference between a pair of focus detection signals (an A image and a B image) obtained from an AF sensor. The focus control unit 133 may execute contrast detection AF. In this case, the focus control unit 133 detects a contrast evaluation value from an image signal obtained from the image sensor 141, and drives the focus lens 131 to a position where the contrast evaluation value is maximum.

The image sensor 141 may be a publicly-known CCD or CMOS color image sensor having, for example, a primary color Bayer array color filter. The image sensor 141 includes a pixel array, in which a plurality of pixels are arranged two-dimensionally, and peripheral circuitry for reading out signals from the pixels. Each pixel has a photoelectric conversion region which accumulates a charge in accordance with an incident light intensity. By reading out, from each pixel, a signal having a voltage corresponding to the charge amount accumulated during an exposure period, a group of pixel signals (analog image signals) representing a subject image formed on the image capture surface by the shooting lens 101 is obtained.

Note that in the present embodiment, the image sensor 141 can generate focus detection signals in addition to the analog image signals. Specifically, each pixel includes a plurality of photoelectric conversion regions (sub pixels). The image sensor 141 is configured to be capable of reading out signals from individual photoelectric conversion regions. For example, assume that each pixel includes two photoelectric conversion regions A and B of the same size arranged in the horizontal direction. In this case, phase detection AF can be executed by generating an A image from the signal read out from the photoelectric conversion region A and a B image from the signal read out from the photoelectric conversion region B for the pixels included in a focus detection area. Accordingly, the signal read out from one of the photoelectric conversion regions A and B can be used as the focus detection signal. Signals read out from both of the photoelectric conversion regions A and B can be used as normal pixel signals. How signals are read out from the image sensor 141 is controlled by an image capture control unit 143 in accordance with instructions from the CPU 151.

The analog image signal read out from the image sensor 141 is supplied to a signal processing unit 142. The signal processing unit 142 applies signal processing such as noise reduction processing, A/D conversion processing, automatic gain control processing, and the like to the analog image signal. The signal processing unit 142 supplies a digital image signal (image data), obtained as a result of applying the signal processing, to the image capture control unit 143. The image capture control unit 143 stores the image signal data supplied from the signal processing unit 142 in the random access memory (RAM) 154.

A motion sensor 162 outputs a signal based on motion of the image capturing apparatus 100. The motion sensor 162 outputs a signal in response to motion in a translational direction and a rotational direction in an orthogonal coordinate system that takes the gravitational direction as the Z axis, for example. The motion sensor 162 may be a combination of an angular velocity sensor and an accelerometer, for example. The motion sensor 162 stores signals in the RAM 154 at regular intervals, for example. The subject detection unit 161 can obtain information on the motion of the image capturing apparatus 100 by referring to the RAM 154.

An image processing unit 152 applies predetermined image processing to the image data held in the RAM 154. The image processing applied by the image processing unit 152 includes, but is not limited to, what is known as development processing, such as white balance adjustment processing, color interpolation (demosaicing) processing, and gamma correction processing, as well as signal format conversion processing, scaling processing, and the like. The image processing unit 152 can also generate information pertaining to the subject luminance, for use in automatic exposure control (AE).

The image processing unit 152 may use the result of detecting the specific subject, supplied from the subject detection unit 161, for white balance adjustment processing and the like, for example. When performing contrast detection AF, the image processing unit 152 may generate an AF evaluation value. The image processing unit 152 stores the image data to which the image processing has been applied in the RAM 154.

When recording image data stored in the RAM 154, the CPU 151 generates a data file according to a recording format by adding a predetermined header, for example, to the image data. In this case, the CPU 151 can reduce the amount of data by encoding the image data using a CODEC 153 as necessary. The CPU 151 records the generated data file into a recording medium 157 such as a memory card, for example.

When displaying the image data stored in the RAM 154, the CPU 151 generates display image data by using the image processing unit 152 to scale the image data to conform to a display size of the display 150. The CPU 151 then writes the display image data into an area of the RAM 154 used as a video memory (a VRAM area). The display 150 reads out the display image data from the VRAM area in the RAM 154 and displays the data.

The image capturing apparatus 100 can cause the display 150 to function as an electronic viewfinder (EVF) by immediately displaying a moving image which is shot during a shooting standby state, moving image recording, and the like in the display 150. The moving image and the frame images thereof displayed when the display 150 is caused to function as an EVF are called a “live view image” or a “through-the-lens image”. Additionally, when shooting a still image, the image capturing apparatus 100 displays the still image shot immediately before in the display 150 for a set period of time such that a user can confirm the shooting result. These display operations are also implemented under the control of the CPU 151.

An input device 156 includes switches, buttons, keys, a touch panel, a gaze input device, and the like provided in the image capturing apparatus 100. Inputs made through the input device 156 are sensed by the CPU 151 through the bus 160, and the CPU 151 controls the function blocks to implement operations in response to the inputs. Note that when the display 150 is a touchscreen, a touch panel included in the display 150 is included in the input device 156.

The CPU 151 controls each function block by, for example, loading a program stored in the ROM 155 into the RAM 154 and executing the program to implement the functions of the image capturing apparatus 100. The CPU 151 also executes AE processing, which automatically determines exposure conditions (shutter speed or accumulation time, aperture value, and sensitivity) on the basis of information on the subject luminance. The information on the subject luminance can be obtained from the image processing unit 152, for example. The CPU 151 may determine the exposure conditions based on the luminance information for an area of the specific subject detected by the subject detection unit 161, such as a person's face, for example.

The CPU 151 controls the operations of the image capture control unit 143 and the aperture control unit 105 based on the determined exposure conditions. The shutter speed is used to control the opening and closing of the aperture stop 103 when shooting a still image, and to control the accumulation time of the image sensor 141 when shooting a moving image. The shooting sensitivity is provided to the image capture control unit 143, and the image capture control unit 143 controls the gain of the image sensor 141 according to the shooting sensitivity.

The result of detecting a part of the specific subject by the subject detection unit 161 can be used by the CPU 151 to automatically set the focus detection area. A tracking AF function can be implemented by automatically setting the focus detection area while following the result of the detection of the same part. AE processing can also be performed based on the luminance information on the focus detection area, and image processing (e.g., gamma correction processing and white balance adjustment processing) can be performed based on the pixel values in the focus detection area. Note that the CPU 151 may display an indicator indicating the location of the focus detection area currently set (e.g., a rectangular frame surrounding the focus detection area) superimposed on the live view image.

A battery 159 is managed by a power management unit 158, and supplies power to the image capturing apparatus 100 as a whole.

The RAM 154 is used to load programs executed by the CPU 151, temporarily store variables and the like while programs are being executed, and the like. The RAM 154 is also used as a temporary storage location for image data to be processed by the image processing unit 152, image data being processed, and image data which has been processed. Furthermore, a part of the RAM 154 is also used as video memory (VRAM) for the display 150.

The ROM 155 is a rewritable non-volatile memory. The ROM 155 stores programs executed by the CPU 151, various types of setting values and GUI data of the image capturing apparatus 100, and the like.

For example, when a transition from a power off state to a power on state is instructed through an operation made in the input device 156, the CPU 151 loads a program stored in the ROM 155 into a part of the RAM 154. The image capturing apparatus 100 transitions to a shooting standby state as a result of the CPU 151 executing the program. When the image capturing apparatus 100 transitions to the standby state, the CPU 151 executes processing for the shooting standby state, such as the live view display.

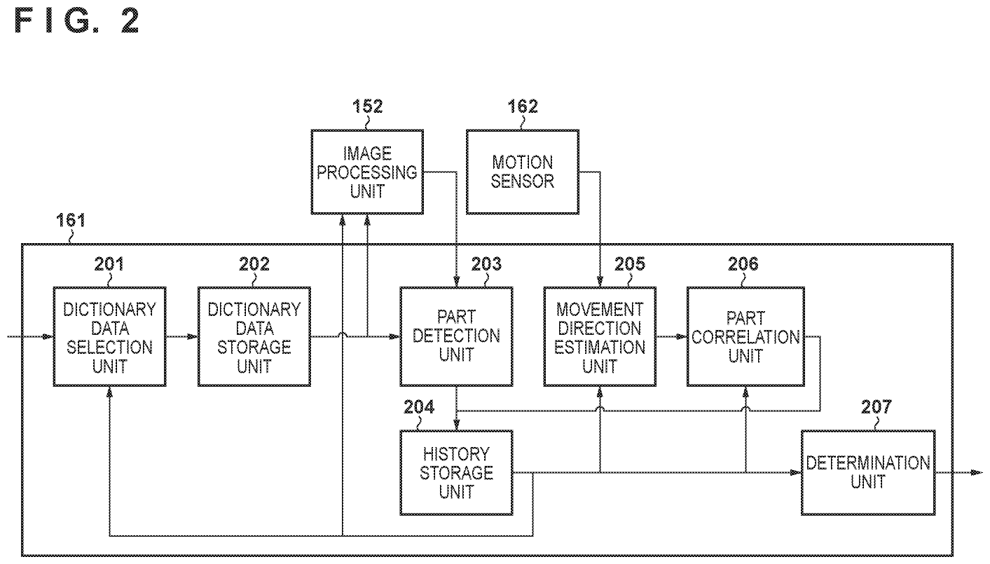

Configuration of Subject Detection Unit FIG. 2 is a block diagram mainly illustrating an example of the functional configuration of the subject detection unit 161. The subject detection unit 161 includes a dictionary data selection unit 201, a dictionary data storage unit 202, a part detection unit 203, a history storage unit 204, a movement direction estimation unit 205, a part correlation unit 206, and a determination unit 207. Although illustrated as an independent function block in FIG. 1, the subject detection unit 161 may actually be implemented by the CPU 151 executing a program, or by the image processing unit 152.

The part detection unit 203 detects a plurality of parts of the specific subject using a convolutional neural network (CNN) in which trained parameters are set. The trained parameters for each specific subject and part to be detected are stored as dictionary data in the dictionary data storage unit 202. The part detection unit 203 can have individual CNNs according to the combination of the type of the specific subject to be detected and the part to be detected. The part detection unit 203 may be implemented using a Graphics Processing Unit (GPU) or a circuit for performing CNN operations at high speeds (a Neural Processing Unit (NPU)).

Machine learning of the parameters of the CNN can be performed through any publicly-known method according to the structure thereof. For example, assume that the CNN has a layered structure in which multiple convolutional layers and pooling layers are arranged in an alternating manner, with a fully-connected layer and an output layer connected to each other. In this case, error back propagation (back propagation) can be used to perform the machine learning of the CNN. If the CNN is a neocognitron CNN, which is a set of feature detection layers (S layers) and feature integration layers (C layers), a training method called “add-if silent” can be used, for example. The CNN configurations and training methods described here are merely examples and are not intended to limit the CNN configuration and training method.

The machine learning of the CNN can be performed on a computer separate from the image capturing apparatus 100, such as a server, for example. In this case, the image capturing apparatus 100 can use the trained CNN obtained from the computer. It is also assumed here that the machine learning is supervised learning. Specifically, training image data in which specific subjects appear and supervisory data (annotations) corresponding to the training image data are assumed to be used to perform the machine learning of the CNN used in the part detection unit 203. The supervisory data includes at least position information of the part of the specific subject to be detected by the part detection unit 203. Note that the machine learning of the CNN may be performed by the image capturing apparatus 100.

The part detection unit 203 inputs image data captured using the image sensor 141 to the trained CNN (the trained model) and outputs the position and size of a part of the specific subject, a detection reliability, and the like as detection results. Because the part detection unit 203 detects the part directly, rather than detecting the part after detecting the specific subject, information on which subject the detected part belongs to is not included in the detection result. Detection is also performed individually for each part.

The part detection unit 203 is not limited to a configuration that uses a trained CNN. For example, the part detection unit 203 may be implemented using a trained model generated by machine learning, such as a support vector machine or decision tree.

The part detection unit 203 need not be a trained model generated through machine learning. For example, dictionary data generated on the basis of rules may be used rather than machine learning. The dictionary data generated on the basis of rules is, for example, image data of parts of the specific subject or feature data specific to parts of the specific subject, determined by a designer. By comparing the image data or the feature data included in the dictionary data with the image data that has been shot or features thereof, the part of the specific subject can be detected. Rule-based dictionary data is simpler and contains less data than a trained model generated through machine learning. As such, subject detection using rule-based dictionary data has a lower processing load and can be executed faster than when using a trained model.

The history storage unit 204 stores the detection result from the part detection unit 203 and information on subject parts associated by the part correlation unit 206. The history storage unit 204 also supplies the stored history to the dictionary data selection unit 201. The history storage unit 204 is assumed to store, as a detection history, the dictionary data used in the detection, the position and size of the detected subject area, the detection reliability, and information on the correlated parts. However, the configuration is not limited thereto, and other information pertaining to the detection, such as the number of detections, identification information of the image data on which the detection was performed (a filename or the like), or the like may be used.

The dictionary data storage unit 202 stores the trained parameters for detecting parts of the specific subject as dictionary data. The dictionary data storage unit 202 stores individual pieces of dictionary data for each of combinations of types and parts of specific subjects. For example, for a specific subject of “human”, the dictionary data storage unit 202 can store dictionary data for detecting a “head” and dictionary data for detecting a “trunk”. Dictionary data for taking a portion of a part as another part may also be stored. For example, dictionary data for detecting faces in the heads of humans or animals, dictionary data for detecting parts of the face (eyes, pupils, or the like), and the like may be stored.

The dictionary data selection unit 201 reads out, from the dictionary data storage unit 202, dictionary data according to a detection target of the part detection unit 203, and supplies the dictionary data to the part detection unit 203. The dictionary data selection unit 201 can supply the dictionary data to the part detection unit 203 in an order based on the detection history stored in the history storage unit 204, for example.

The movement direction estimation unit 205 estimates a movement direction of the specific subject based on the detection result from the part detection unit 203, the detection history stored in the history storage unit 204, and the motion of the image capturing apparatus 100 detected by the motion sensor 162.

Apart correlation unit 206 specifies parts belonging to the same subject from among the parts detected by the part detection unit 203, and associates those parts with each other, taking into account the movement direction of the subject estimated by the movement direction estimation unit 205.

The determination unit 207 determines a main subject from the specific subject including the parts associated by the part correlation unit 206. If there is one specific subject, the determination unit 207 takes that specific subject as the main subject. If there are a plurality of specific subjects, the determination unit 207 determines one as the main subject. The determination unit 207 can determine the main subject through any publicly-known method based on the position and/or size of the subject area, user settings, or the like.

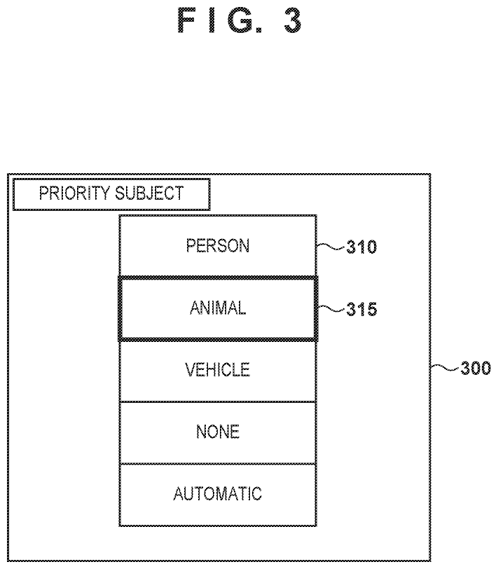

FIG. 3 illustrates an example of a setting screen for a specific subject to be detected with priority by the subject detection function of the image capturing apparatus 100 (a priority subject). A setting screen 300 can be called from, for example, a menu screen, through an operation made in the input device 156, for example. The setting screen 300 includes a list 310 that displays types of priority subjects that can be selected. The list 310 includes types of specific subjects that can be detected by the subject detection unit 161, as well as “automatic”, which indicates that there is no priority subject. The list 310 also includes “none”, which indicates that the detection of specific subjects is deactivated.

Note that if the specific subjects are classified hierarchically, the priority subject may be capable of being set for any desired level in the hierarchy. For example, if organism subjects include humans and animals, and animals include dogs and cats, horses, and birds, the priority subject may be capable of being set to any one of “horse”, “animal”, and “organism”.

The user can move a cursor 315 within the list 310 by operating the input device 156 (e.g., a directional key). The user can execute a setting by operating the input device 156 (e.g., a set button) in a state where a desired setting is selected by the cursor 315. The CPU 151 stores the item selected when the set button is operated as a setting pertaining to the priority subject in the ROM 155, for example.

When a priority subject is set, the determination unit 207 determines the priority subject as the main subject with priority. Note that when the priority subject is set to a classification that includes lower levels of a hierarchy, such as “animal”, the determination unit 207 determines the main subject from among subjects of the types in the lowest level. For example, assume that the priority subject is set to “animal”, and the lowest level of “animal” includes “dogs and cats, horses, and birds”. In this case, the determination unit 207 determines one of dogs and cats, horses, and birds, which has been detected, as the main subject. If a plurality are detected, the determination unit 207 can determine the main subject using a publicly-known method, such as the subject having a detection position that is closest to the center of the image, the subject having the largest detection size, the subject having the highest reliability, or the like.

Subject Detection Processing

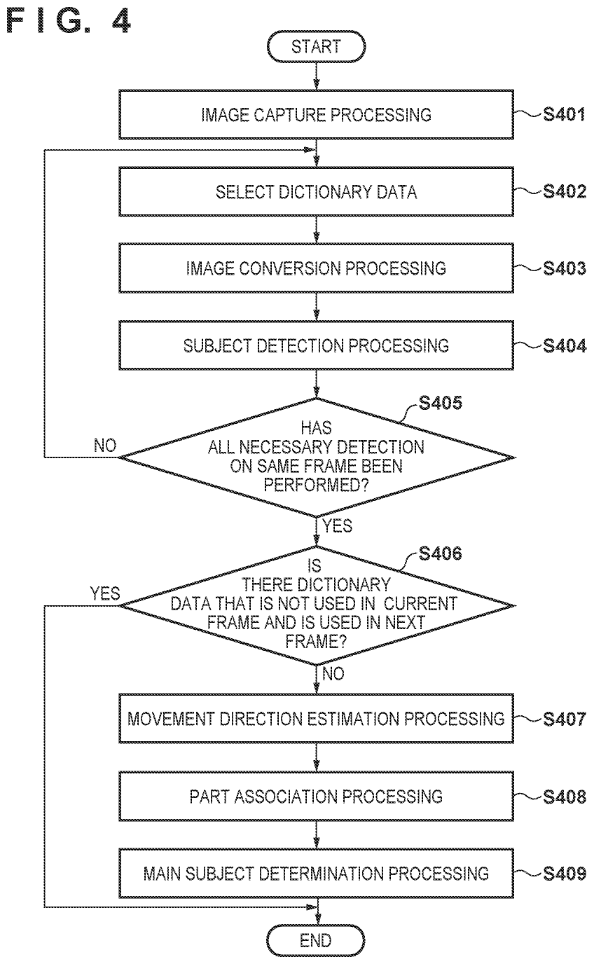

The subject detection processing will be described with reference to the flowchart in FIG. 4. Note that the operations described hereinafter assume that the image capturing apparatus 100 is turned on and is in the shooting standby state. The shooting standby state is assumed to be a state of standing by for a shooting (preparation) instruction for a still image or a moving image while continuously executing a live view display.

The series of processing from step S401 to S408 is assumed to be executed by the image capture control unit 143 of the image capturing apparatus 100 within a single frame period of a moving image for the live view display, but may instead be executed over a period including a predetermined plurality of frames. For example, a result of subject detection in a first frame may be applied from any frame including and after a second frame.

In step S401, the CPU 151 executes one frame's worth of shooting by controlling the image capture control unit 143. An analog image signal read out from the image sensor 141 is supplied to a signal processing unit 142.

In step S402, the dictionary data selection unit 201 of the subject detection unit 161 selects the dictionary data to be used in the subject detection. As described above, the dictionary data is parameters generated through training by an external device, and is set and used in the CNN of the part detection unit 203.

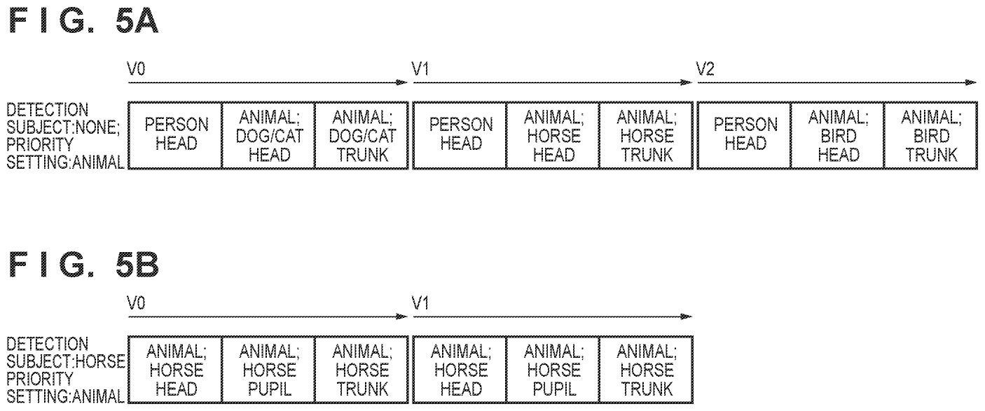

Dictionary data switching operations performed by the dictionary data selection unit 201 will be described with reference to FIGS. 5A and 5B. As described above, the dictionary data storage unit 202 stores individual pieces of dictionary data for each of combinations of subject type and part type to be detected. Then, the subject and the part to be detected by the CNN can be changed by switching the dictionary data set in the CNN. Accordingly, when detecting the head and the trunk of a human for a single frame of an image, for example, it is necessary to apply detection processing using dictionary data for detecting the head of a human and detection processing using dictionary data for detecting the trunk of a human to the image data of the same frame.

On the other hand, the time during a single frame period (a single vertical synchronization period) in which the subject detection processing can be used is limited by the framerate, the exposure time, and the like. Accordingly, it is possible that only a limited number of pieces of dictionary data can be used, particularly when executing the subject detection processing on each frame.

For this reason, the dictionary data selection unit 201 determines the type and order of use of the dictionary data to be used in the subject detection processing, taking into account whether or not there is a specific subject to be prioritized, the detection history, and the like. An example of the operations by the dictionary data selection unit 201 will be described with reference to FIGS. 5A and 5B.

It is assumed here that the subject detection processing is executed while switching the dictionary data three times in a single frame period. It is also assumed that “animal” is set as the priority subject. V0, V1, and V2 indicate the vertical synchronization periods of the first to third frames, respectively.

FIG. 5A illustrates an example of switching operations for the dictionary data supplied by the dictionary data selection unit 201 to the part detection unit 203 when no specific subject is detected. In this case, in the first frame, the dictionary data selection unit 201 supplies dictionary data for the head of a person, dictionary data for an animal (dog/cat head), and dictionary data for an animal (dog/cat trunk) to the part detection unit 203 in that order. In the second frame, the dictionary data selection unit 201 supplies dictionary data for the head of a person, dictionary data for an animal (horse head), and dictionary data for an animal (horse trunk) to the part detection unit 203 in that order. Then, in the third frame, the dictionary data selection unit 201 supplies dictionary data for the head of a person, dictionary data for an animal (bird head), and dictionary data for an animal (bird trunk) to the part detection unit 203 in that order.

In the present embodiment, during a period where no specific subject is detected, the dictionary data selection unit 201 supplies the dictionary data for detecting the head of a person and the dictionary data for detecting the priority subject in each frame. Because “animal” is set as the priority subject here, the dictionary data selection unit 201 supplies the dictionary data for detecting the head and trunk of “dog/cat, horse, and bird”, which are subordinate to “animal”, to the part detection unit 203 sequentially. As a result, the detection processing for all types of animals that can be detected is performed over a period of three frames.

Note that of the dictionary data for detecting different parts of specific subjects of the same type, dictionary data for detecting a large part may be selected with the priority for the dictionary data to be used during periods when no specific subject is detected. For example, when dictionary data is present for four parts, namely “head”, “trunk”, “face”, and “pupil”, the dictionary data for detecting “trunk” and “head” is selected with priority over the dictionary data for detecting “face” and “pupil”.

Additionally, the selection priority can be lowered for dictionary data for subjects unlikely to be present at the same time. For example, if the priority subject is set to animals, dictionary data pertaining to subjects such as “aircraft”, “trains”, and the like can be set not to be selected (not to be detected). This makes it possible to increase the frequency of the detection processing for the priority subject.

FIG. 5B illustrates an example of operations for selecting dictionary data when the trunk and/or the head of a horse was detected in the previous frame. In the first frame, the dictionary data selection unit 201 supplies dictionary data for animal (horse head), animal (horse pupil), and animal (horse trunk) to the part detection unit 203 in that order. If the priority subject has been detected in all frames, the dictionary data selection unit 201 selectively supplies the dictionary data pertaining to the detected priority subject to the part detection unit 203.

By supplying the dictionary data for detecting different parts of the same type of subject in order to the part detection unit 203, even if one part of a subject is not detected, the tracking of the same subject can be continued if another part is detected. Although the example in FIG. 5B illustrates supplying only the dictionary data pertaining to the detected priority subject, this does not preclude supplying the dictionary data pertaining to other subjects. For example, for each vertical synchronization period (or each predetermined number of vertical synchronization periods), the final dictionary data supplied may be changed to dictionary data for detecting a person (head). This makes it possible to detect a subject aside from the priority subject, such as a person riding a horse in the example in FIG. 5B, for example.

Note that even with a configuration in which three instances of subject detection processing are performed in a single vertical synchronization period by the part detection unit 203 executing three instances of subject detection processing in parallel, the dictionary data selection unit 201 can correspondingly select three pieces of dictionary data. However, because there is no priority to the order of execution of the instances of subject detection processing, the three pieces of dictionary data are input from the dictionary data selection unit 201 to the part detection unit 203 in parallel.

Returning to FIG. 4, in step S403, the image processing unit 152 processes the image data into a state suited to the subject detection processing. The image processing unit 152 reduces the image size to reduce the amount of processing, for example. The image processing unit 152 may reduce the entire image, or may reduce the image size by cropping the image. Depending on the detected part, cropping can improve the accuracy of the subject detection processing.

The image processing unit 152 can crop the image in accordance with the detected part, for example. For example, when detecting a small part such as a pupil, cropping the area containing the pupil can reduce the image size without reducing the size of the pupil area, as opposed to reducing the entire image. Furthermore, cropping reduces unnecessary areas, which can be expected to improve the detection accuracy.

The image processing unit 152 can specify the detected part by obtaining information in the dictionary data supplied to the part detection unit 203 from the dictionary data selection unit 201 or the dictionary data storage unit 202. The image processing unit 152 can also obtain information on the detection position and size of the part from the detection results for frames before the current frame, which are stored in the history storage unit 204. Based on this information, the image processing unit 152 can determine the range for cropping the image.

For example, when detecting the pupil of a horse, determining the cropping range so as to be centered on the detection position of the head of the horse makes it possible to crop out the range in which the pupil of the horse appears. The size of the area to be cropped can be taken as the input image size for the CNN when, for example, the input image size for the CNN is at least the detection size. When the input image size for the CNN is smaller than the detection size, the image may be cropped to a size based on the detection size and then reduced to the input image size for the CNN. Note that these are merely examples, and the cropping may be performed using another method.

The image processing unit 152 supplies the data of the size-adjusted image to the part detection unit 203 of the subject detection unit 161.

In step S404, the part detection unit 203 obtains the dictionary data selected by the dictionary data selection unit 201 from the dictionary data storage unit 202 and sets that dictionary data in the CNN. The part detection unit 203 then inputs the image data supplied from the image processing unit 152 into the CNN and applies the subject detection processing. The part detection unit 203 outputs the detection result to the part correlation unit 206 and the history storage unit 204. The detection result can include the position and size of the part of the specific subject which has been detected, the detection reliability, the dictionary data used, information specifying the image data, and the like, but is not limited thereto.

Upon receiving the detection result from the part detection unit 203, the history storage unit 204 stores the detection result. Note that the history storage unit 204 may be configured to delete old history items that satisfy a predetermined condition.

In step S405, the dictionary data selection unit 201 determines whether the subject detection processing has been executed for all parts to be detected in the current frame. In the case of FIG. 5A, this determination corresponds to the determination as to whether the subject detection processing to be executed in a Vn period (where n is 0, 1, or 2) has been executed (whether the subject detection processing has been executed using the three pieces of dictionary data).

If the subject detection processing to be executed for the current frame is determined not to be complete, the processing is executed again from step S402, and the dictionary data selection unit 201 selects the next piece of dictionary data. On the other hand, if the subject detection processing to be executed for the current frame is determined to be complete, step S406 is executed.

In step S406, the dictionary data selection unit 201 determines whether there is dictionary data, among the dictionary data not used for the current frame, which is to be used for the next frame. For this determination, a determination of “yes” can be made when the subject detection processing for all of the parts to be detected is executed over a plurality of frames, as illustrated in FIG. 5A. Specifically, when the current frame corresponds to the first frame or the second frame in FIG. 5A, the dictionary data selection unit 201 makes a determination of “yes”. On the other hand, when the current frame corresponds to the third frame in FIG. 5A, or the first frame or the second frame in FIG. 5B, the dictionary data selection unit 201 makes a determination of “no”.

If a determination of “yes” is made in step S406, the processing of steps S407 to S409 is skipped, and the processing moves to the next frame. On the other hand, if a determination of “no” is made in step S406, step S407 is executed. Note that even if a determination of “yes” is made in step S406, the processing from step S407 and on may be executed if it is necessary to use the subject detection result. This is a situation, for example, where a fast response is required, such as when executing autofocus operations to focus on the detected subject.

In step S407, the movement direction estimation unit 205 estimates the movement direction of the specific subject detected in the current frame based on the detection history stored in the history storage unit 204 and the motion of the image capturing apparatus obtained by the motion sensor 162. Details of this will be given later.

In step S408, the part correlation unit 206 associates the parts detected in the current frame on a subject-by-subject basis, taking into account the movement direction estimated by the movement direction estimation unit 205. Details of this will be given later.

In step S409, the determination unit 207 determines the main subject from the specific subjects detected in the current frame. If, for example, a person and a horse are detected in the current frame and the priority subject is set to “animal”, the determination unit 207 determines the horse as the main subject. On the other hand, if the priority subject is set to “person” or “automatic”, the determination unit 207 determines the person as the main subject.

If the priority subject which is set is not detected, or a plurality of priority subjects are detected, the determination unit 207 can determine the main subject based on at least one of the detection position, size, and reliability. In step S409, the CPU 151 may display some or all of the information pertaining to the main subject determined by the determination unit 207 in the display 150.

Movement Direction Estimation Processing

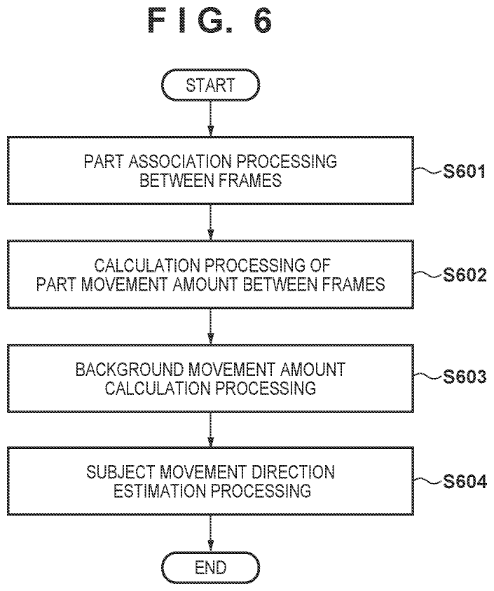

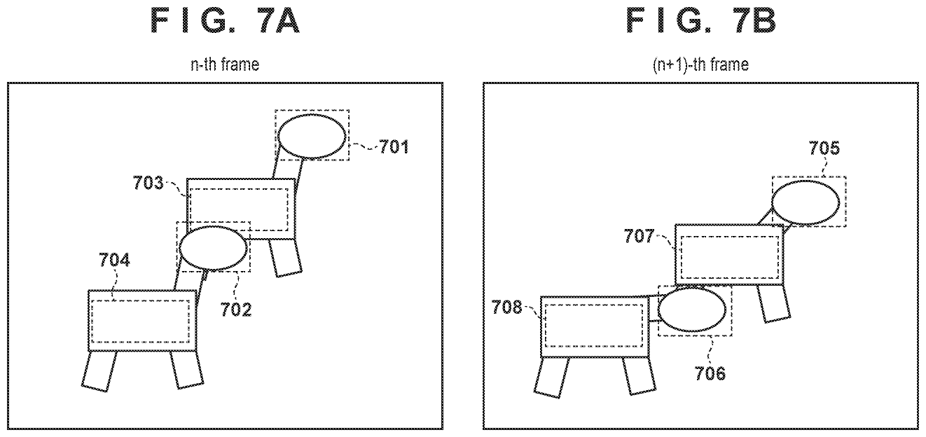

The movement direction estimation processing performed in step S407 will be described with reference to FIG. 6 and FIGS. 7A to 7B.

FIG. 7A schematically illustrates an n-th frame of a moving image, and FIG. 7B schematically illustrates an n+1-th frame following the n-th frame. It is assumed that heads 701 and 702 of an animal and trunks 703 and 704 of an animal have been detected through the subject detection processing performed on the n-th frame. It is also assumed that heads 705 and 706 of an animal and trunks 707 and 708 of an animal have been detected through the subject detection processing performed on the n+1-th frame. Furthermore, it is assumed that the head 706 of the animal is detected closer to the trunk 707 of the animal than the head 705 of the animal.

The movement direction estimation processing performed when the n+1-th frame in FIG. 7B is taken as the current frame will be described with reference to the flowchart illustrated in FIG. 6.

In step S601, the movement direction estimation unit 205 associates parts of the same type between frames based on the detection result history for the current frame (the n+1-th frame) and the previous frame (the n-th frame) stored in the history storage unit 204.

The movement direction estimation unit 205 associates the heads of the animals detected in the n+1-th frame with the heads of the animals detected in the n-th frame that are closest in distance (detection position). Specifically, the movement direction estimation unit 205 associates the head 705 of the animal detected in the n+1-th frame with the head 701 of the animal detected in the n-th frame. Likewise, the movement direction estimation unit 205 associates the head 706 of the animal detected in the n+1-th frame with the head 702 of the animal detected in the n-th frame. The movement direction estimation unit 205 performs similar association for the trunks of the animals as well.

Note that the association may be performed using a different method. For example, a correlation computation with the area of the part detected in the n+1-th frame may be performed using the area of the part detected in the n-th frame as a template, and parts having the highest correlation may be associated with each other.

In step S602, the movement direction estimation unit 205 calculates a movement amount between frames for each part, based on the detection positions of the parts associated with each other in step S601. Here, as the movement amount, the movement direction estimation unit 205 calculates a vector taking the detection position in the n-th frame as a starting point and the detection position in the n+1-th frame as an ending point.

In step S603, the movement direction estimation unit 205 calculates a background movement amount between frames (a movement amount for the entire frame). Here, the movement direction estimation unit 205 calculates the background movement amount through the following Equation (1) and Equation (2), based on the focal length (angle of view) of the shooting lens 101 and the motion of the image capturing apparatus 100 obtained from the motion sensor 162.

GlobalVec(x)=f×tan(Yaw)×imagewidth (1)

GlobalVec(y)=f×tan(Pitch)×imageheight (2)

GlobalVec(x) and GlobalVec(y), calculated through Equation (1) and Equation (2), are a horizontal component and a vertical component of the vector indicating the background movement amount. The focal length is represented by f, and of the motion of the image capturing apparatus 100 obtained from the motion sensor 162, a rotation amount about the Y axis is represented by Yaw (°), and a rotation amount about the X axis is represented by Pitch (°). “imagewidth” and “imageheight” are coefficients indicating the size of the image in the horizontal direction and the vertical direction.

Note that the movement amount of the entire frame may be calculated through another publicly-known method. For example, a background area may be detected in the n-th frame and template matching using part of that background area as the template may be applied to the n+1-th frame to find the movement amount between frames with the template as the background movement amount. Alternatively, a motion vector between frames may be detected for each image, and the value having a maximum frequency in a histogram for each directional component of the motion vector may be found as a directional component of the background movement amount.

In step S604, the movement direction estimation unit 205 estimates the movement direction of the subject including the parts based on the following Inequations (3) to (5), from the movement amount between frames for each part calculated in step S602 and the background movement amount calculated in step S603.

TH<TargetVec(x)−GlobalVec(x) (3)

TargetVec(x)−GlobalVec(x)<−TH (4)

−TH≤TargetVec(x)−GlobalVec(x)<TH (5)

TargetVec(x) represents the horizontal component of the movement amount between frames of the parts calculated in S602, and GlobalVec(x) represents the horizontal component of the background movement amount calculated in S603. TH represents a threshold with a positive value.

If Inequation (3) is true, the movement direction estimation unit 205 estimates that the subject is moving to the right in the screen.

If Inequation (4) is true, the movement direction estimation unit 205 estimates that the subject is moving to the left in the screen.

If Inequation (5) is true, the movement direction estimation unit 205 estimates that the subject is not moving to the left or the right.

Note that the movement amount of the subject and the vertical direction can be estimated by replacing TargetVec(x) and GlobalVec(x) in Inequations (3) to (5) with TargetVec(y) and GlobalVec(y) as follows.

If Inequation (3) is true, the movement direction estimation unit 205 estimates that the subject is moving downward in the screen.

If Inequation (4) is true, the movement direction estimation unit 205 estimates that the subject is moving upward in the screen.

If Inequation (5) is true, the movement direction estimation unit 205 estimates that the subject is not moving upward or downward.

Note that the movement amount of the subject may be a representative value of the movement amounts calculated for the associated parts, or may be a movement amount calculated for a single set of associated parts. The representative value may be the average value, the median value, or another value. When calculating the movement amount only for one set of parts, the movement direction estimation unit 205 uses the parts corresponding to the subject determined to be the main subject in the previous frame.

If a plurality of parts have been detected for the main subject, the movement direction estimation unit 205 calculates the movement amount for each individual part. Then, the horizontal component of the vector, among the vectors representing the movement amount, having the lowest movement amount in the vertical direction is estimated to be the movement amount in the horizontal direction. This makes it possible to obtain stable estimation results.

For example, when an animal subject is moving in the horizontal direction, there are situations where the motion of the trunk in the vertical direction is low, but the motion of the head in the vertical direction is high due to neck motion. As such, using the movement amount obtained for the part having little motion in the vertical direction makes it possible to obtain stable estimation results. If the reliability of the movement amount can be determined according to the type of the part, it is acceptable to obtain only the movement amount of the part having a high reliability, without calculating the motion in the vertical direction. For example, when the head and the trunk are detected for an animal subject, it is acceptable to calculate the movement amount of the trunk.

Additionally, the movement direction may be estimated based on estimation results for a plurality of frames. For example, the estimation result for the movement direction may be output only when the same movement direction is estimated for a predetermined plurality of consecutive frames. If the same movement direction is not estimated for the predetermined plurality of consecutive frames even after a certain period of time passes, the movement direction estimation unit 205 may output a result indicating that the movement direction cannot be estimated.

Part Association Processing

The processing for associating parts performed in step S408 will be described next with reference to FIGS. 7A and 7B.

In step S408, the part correlation unit 206 estimates and associates parts that are of different types but belong to the same subject, based on the movement direction estimated in step S407.

In step S407, it is assumed that all of the animal subjects are moving to the right in the screen. It is furthermore assumed that the heads 705 and 706 of the two animals are detected within a range where the distance from the trunk 707 of the animal detected in the current frame (the n+1-th frame in FIG. 7B) is less than a threshold.

In this case, the part correlation unit 206 associates the trunk 707 of the animal detected in the current frame with the head 705 among the heads 705 and 706 of the two animals for which the distance is less than the threshold. This is due to the fact that of the heads 705 and 706, the head 705 satisfies a positional relationship between the trunk and the head specified based on the estimated movement direction. The head 706 is closer to the trunk 707 than the head 705, but does not satisfy the positional relationship between the trunk and the head specified based on the estimated movement direction.

In other words, based on the estimated movement direction of the subject, the part correlation unit 206 estimates that of the heads 705 and 706 at distances from the trunk 707 that are less than the threshold, the head 705 belongs to the same subject as the trunk 707, and the head 706 belongs to a different subject. The part correlation unit 206 then associates the trunk 707 with the head 705.

The part correlation unit 206 also associates the trunk 708 with the head 706, which is closer than the trunk 707 in the right direction. This is because the movement directions for the subjects are both estimated to be the right direction, and although the head corresponding to the trunk 707 is assumed to be present to the right of the trunk 707, the head 706, which is present to the left of the trunk 707, is assumed not to correspond to the trunk 707.

Note that if the movement direction of the subject is estimated to be stationary in step S407, it is determined that the movement direction cannot be estimated, or no estimation results have been obtained, parts cannot be associated taking into account the estimated movement direction. In this case, the part correlation unit 206 can associate other types of parts for which the distance is less than the threshold based on, for example, the detection positions of the parts. At this time, if a plurality of candidates for association are present, the part correlation unit 206 may skip the association by giving priority to avoiding erroneous associations.

For example, for the trunk 707 of the animal, the heads 705 and 706 of two animals are present at distances within a predetermined range. In this case, the part correlation unit 206 does not associate the trunk 707 of the animal with either of the heads. However, if the head corresponding to the trunk 707 can be narrowed down to a single candidate based on the results of associating other parts, the head may be associated with the trunk 707 at that point in time. The association may also be performed having narrowed down the plurality of candidates to a single candidate by taking into account other conditions, such as by referring to the association results from the previous frame.

As described above, according to the present embodiment, for different parts detected for subjects of the same type, taking into account the movement direction of the subjects when associating parts belonging to the same subject makes it possible to improve the accuracy of the association. Although an animal subject has been described here, the embodiment can be applied in the same manner when associating parts pertaining to other types of subjects for which the positional relationships of the parts can be specified based on the movement direction.

### Second Embodiment

A second embodiment of the present invention will be described next. The present embodiment is the same as the first embodiment aside from the configuration and operations of the subject detection unit. As such, configurations aside from the subject detection unit will not be described.

Configuration of Subject Detection Unit

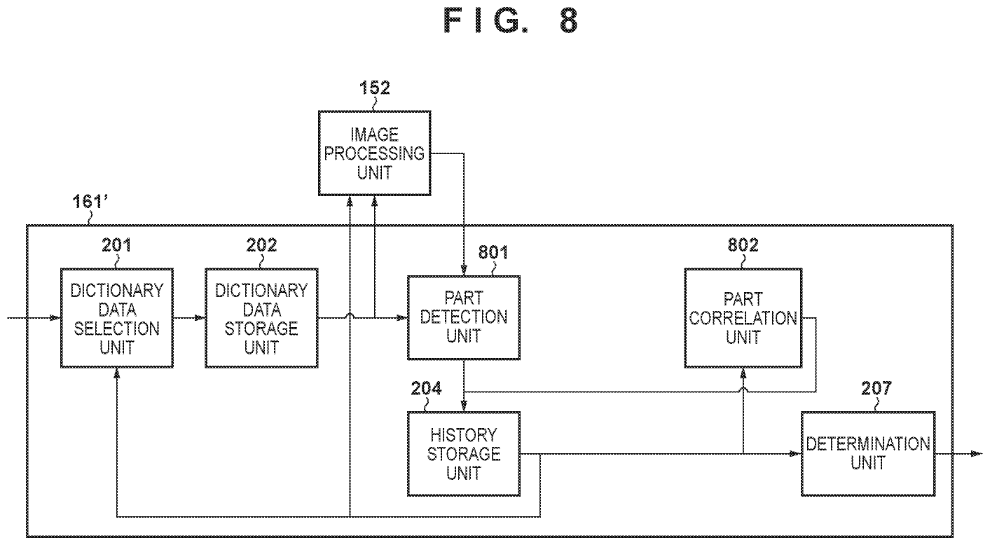

FIG. 8 illustrates an example of the configuration of a subject detection unit 161′ according to the second embodiment in the same manner as in FIG. 2. Configurations that are the same as in the first embodiment are given the same reference signs as in FIG. 2. The subject detection unit 161′ differs from the first embodiment in that the movement direction estimation unit is not provided.

Subject Detection Processing

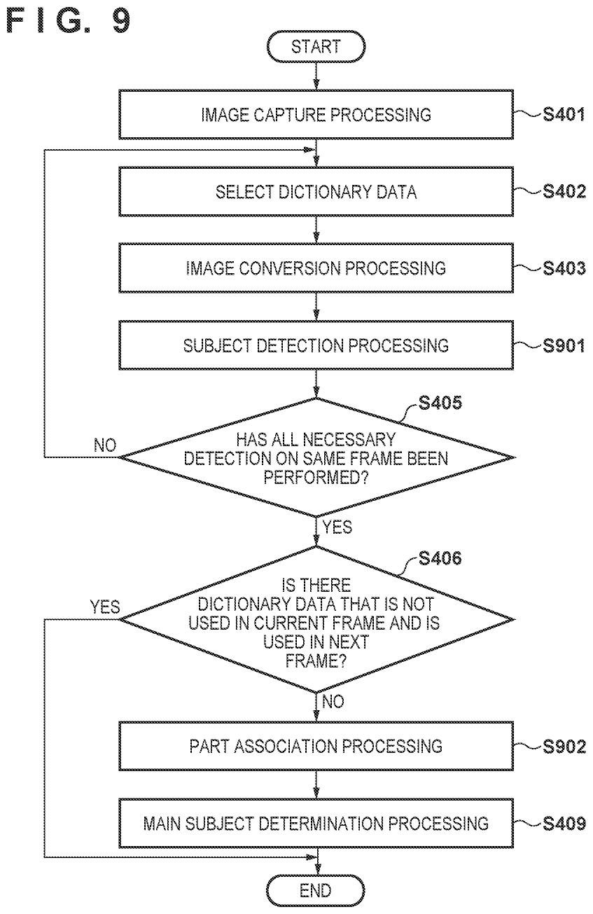

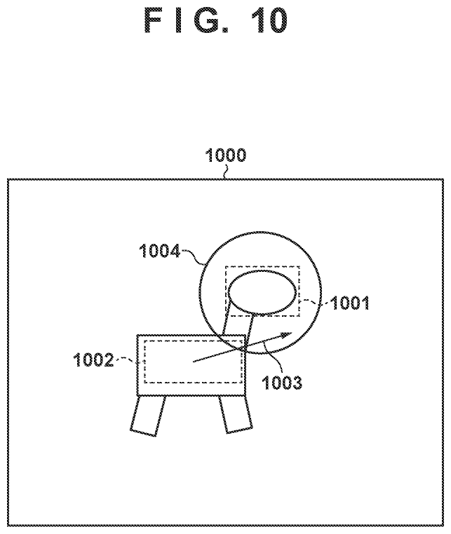

Operations of the subject detection unit 161′ will be described with reference to FIGS. 9 and 10. In the flowchart illustrated in FIG. 9, processing steps that are the same as in the first embodiment are given the same reference signs as in FIG. 4.

Steps S401 to S403 are the same as in the first embodiment, and will therefore not be described here.

The present embodiment assumes that the dictionary data is trained such that the detection result includes a vector indicating a position where it is highly probable that another part of the same subject is present. For example, such dictionary data can be obtained by including, in the supervisory data used when training the parameters for detecting the trunk of an animal subject, not only the position of the trunk, but also a vector from the trunk to another part of the same subject, e.g., the position of the head. Likewise, the supervisory data used when training parameters for detecting the head of an animal subject can include not only the position of the head, but also a vector from the head to another part of the same subject, e.g., the position of the trunk.

In step S901, a part detection unit 801 executes subject detection processing using the dictionary data selected by the dictionary data selection unit 201. This step is the same as step S404, except that due to the dictionary data being different, the detection result includes a position estimation vector indicating a position where it is highly probable that a different part of the same subject is present. The part detection unit 801 of the present embodiment outputs the position estimation vector, and therefore functions as means for estimating a position where another part is present.

FIG. 10 is a diagram illustrating a detection result obtained when the trunk of an animal subject is detected in step S901. It is assumed that a trunk 1002 and a position estimation vector 1003 have been detected as a result of applying processing for detecting the trunk of an animal subject to a current frame 1000.

The part detection unit 801 outputs a detection result including the position estimation vector 1003 to the history storage unit 204. The processing of steps S405 and S406 are then performed in the same manner as in the first embodiment.

Step S902 is executed when a determination of “no” is made in step S406.

In step S902, a part correlation unit 802 associates the parts detected in the current frame on a subject-by-subject basis using the position estimation vector.

The association of parts in step S902 will be described with reference to FIG. 10.

Assume that the trunk 1002 and a head 1001 of an animal subject had been detected as a result of the subject detection processing performed on the current frame 1000. Assume also that the position estimation vector 1003 for the head has been obtained as a result of detecting the trunk 1002.

In this case, the part correlation unit 802 sets a position estimation vector search area 1004 centered on the detection position of the head 1001. The part correlation unit 802 then searches for a position estimation vector for the head which has an ending point present within the search area 1004 that has been set. In the example illustrated in FIG. 10, the ending point of the position estimation vector 1003 is present within the search area 1004. As such, the part correlation unit 802 associates the trunk 1002, which includes the position estimation vector 1003 as a detection result, with the head 1001.

Note that the position estimation vector search area can be determined in accordance with the type, size, and so on of a part that includes the center of the search area (the head, here). Additionally, the position estimation vector search area is set based not on the part that includes the position estimation vector in the detection result (the trunk, here), but rather on another part. However, the search area for the part may be set based on the ending point of the position estimation vector.

In the example illustrated in FIG. 10, the part correlation unit 802 sets the search area for the head centered on the ending point of the position estimation vector 1003 pertaining to the head. The part correlation unit 802 can then associate the head, among the heads of the subjects of the same type detected in the current frame 1000, which has a detection position within the search area, with the trunk 1002.

According to the present embodiment, it is not necessary to estimate the movement direction of the subject, which provides an effect in that parts can be associated accurately while reducing the processing load involved in the association.

### Third Embodiment

A third embodiment of the present invention will be described next. The present embodiment is the same as the first embodiment aside from the configuration and operations of the subject detection unit. As such, configurations aside from the subject detection unit will not be described.

Configuration of Subject Detection Unit

The subject detection unit 161 according to the third embodiment may have the same configuration as that illustrated in FIG. 2, but the operations of the part correlation unit 206 are different. Additionally, similar to the second embodiment, the dictionary data is assumed to be trained such that the detection result includes a vector indicating a position where it is highly probable that another part of the same subject is present. Accordingly, the part detection unit 203 operates in the same manner as the part detection unit 801 of the second embodiment.

Subject Detection Processing

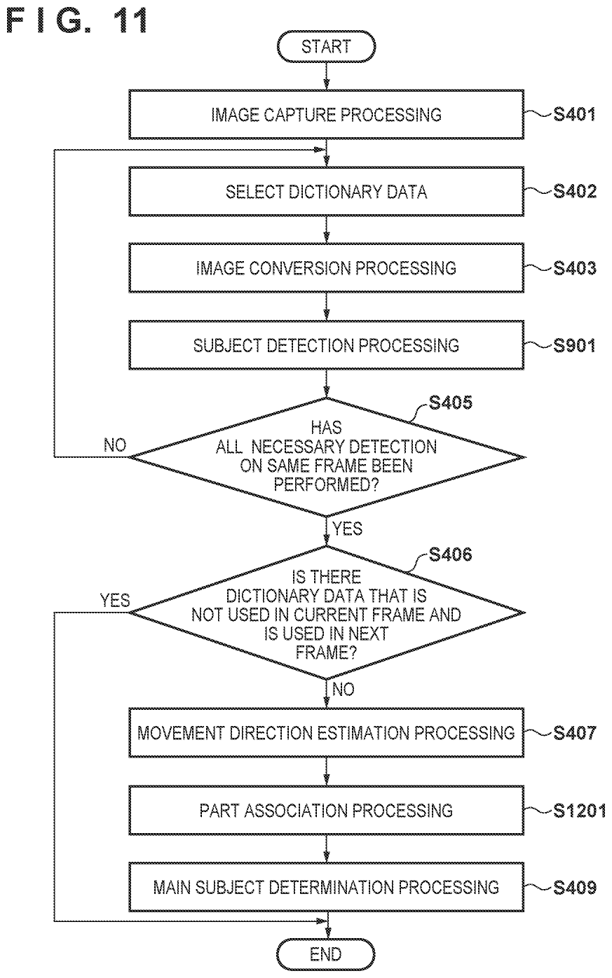

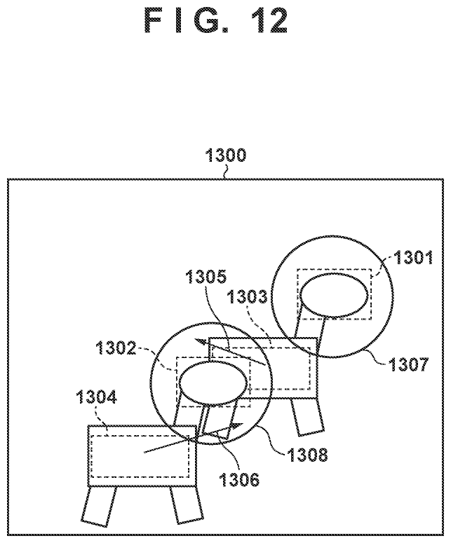

Operations of the subject detection unit 161 will be described with reference to FIGS. 11 and 12. In the flowchart illustrated in FIG. 11, processing steps that are the same as those in the first embodiment are given the same reference signs as in FIG. 4, and processing steps that are the same as those in the second embodiment are given the same reference signs as in FIG. 9.

Steps S401 to S403 and steps S405 to S407 are the same as in the first embodiment, and step S901 is the same as in the second embodiment, and the steps will therefore not be described here.

After the movement direction of the subject is estimated in step S407, in step S1201, the part correlation unit 206 associates the parts detected in the current frame on a subject-by-subject basis using the movement direction estimated in step S407 and the position estimation vector detected in step S901.

The association of parts in step S1202 will be described with reference to FIG. 12.

Assume that trunks 1303 and 1304 and heads 1301 and 1302 of an animal subject have been detected through the subject detection processing performed on a current frame 1300. Assume also that a position estimation vector 1305 has been obtained as a result of detecting the trunk 1303, and a position estimation vector 1306 has been obtained as a result of detecting the trunk 1304. Furthermore, assume that the movement directions of the subjects have been estimated to be the right direction in step S407.

In this case, the part correlation unit 206 sets a position estimation vector search area 1307 centered on the detection position of the head 1301, and a position estimation vector search area 1308 centered on the detection position of the head 1302.

The part correlation unit 206 searches for a position estimation vector having an ending point present within the search area for each of the set search areas 1307 and 1308. In the example illustrated in FIG. 12, no position estimation vector has an ending point within the search area 1307. Accordingly, a trunk to be associated with the head 1301 cannot be specified. On the other hand, the ending points of the two position estimation vectors 1305 and 1306 are present in the search area 1308.

When a plurality of position estimation vectors having ending points within a search area are present, the part correlation unit 206 takes the movement directions of the subjects into account. Here, the movement directions of the subjects are both estimated to be the right direction. As such, the part correlation unit 206 associates the head 1302 with the trunk 1304 based on the position estimation vector 1306 having an ending point to the right of the starting point, which is consistent with the estimated movement direction.

Note that with the head 1302 being associated with the trunk 1304, the only parts detected in the current frame 1300 which have not been associated are the head 1301 and the trunk 1303. In this case, the part correlation unit 206 may associate the head 1301 with the trunk 1303 taking into account the fact that the distance between the head 1301 and the trunk 1303 is less than a threshold, and that the positional relationship between the head and the trunk is consistent with the estimated movement direction.

According to the present embodiment, parts are associated with each other taking into account both the estimated movement direction of the subjects and the position estimation vectors of the parts, which makes it possible to further increase the reliability of the association.

### OTHER EMBODIMENTS

For ease of descriptions and understanding, the foregoing embodiments described cases where two parts are detected for one type of subject. However, a situation where three or more parts are detected for one type of subject can be handled in a similar manner by performing the association for two parts at a time. Additionally, when detecting a plurality of types of subjects, the above-described association of parts may be executed for each type of subject.

The present invention is not limited to live-action images, and can also be applied to CG images. For example, the present invention can also be applied to images obtained by cropping out a predetermined angle of view from a user's (avatar's) viewpoint position within a virtual space.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-141519, filed on Sep. 6, 2022, which is hereby incorporated by reference herein in its entirety.

What is claimed is:

1. An image processing apparatus comprising:
one or more processors that execute a program stored in a memory and thereby function as:
a detection unit that detects a first part and a second part of a specific subject from an image;
an estimation unit that estimates a movement direction of the specific subject; and
an association unit that, based on the estimated movement direction, associates parts of the same subject, among the first part and the second part detected by the detection unit.

2. The image processing apparatus according to claim 1,
wherein a positional relationship between the first part and the second part can be specified by the movement direction of the specific subject, and
the association unit associates the first part and the second part so as to satisfy the positional relationship specified by the estimated movement direction.

3. The image processing apparatus according to claim 1,
wherein the association unit associates the first part and the second part which satisfy the positional relationship specified by the estimated movement direction, and which are at a distance less than a threshold.

4. The image processing apparatus according to claim 1,
wherein when the estimation unit cannot estimate the movement direction, the association unit associates the first part and the second part which are at a distance less than a threshold.

5. The image processing apparatus according to claim 4,
wherein when the estimation unit cannot estimate the movement direction, the association unit skips associating the second part with the first part for which a plurality of the second parts at a distance less than the threshold are present.

6. The image processing apparatus according to claim 1,
wherein the estimation unit estimates the movement direction based on a vector, among vectors indicating movement amounts for each of specific subjects each being the specific subject, which has a lowest movement amount in a vertical direction.

7. The image processing apparatus according to claim 1,
wherein when detecting the first part, the detection unit detects vectors indicating a position where the second part is highly probable to be present, and
the association unit associates the first part for which is detected a vector, among the vectors having ending points within a search area set on the second part, which is consistent with the estimated movement direction, with the second part.

8. An image processing apparatus comprising:
one or more processors that execute a program stored in a memory and thereby function as:
a detection unit that detects a first part and a second part of a specific subject from an image, wherein a detection result for the first part includes vectors indicating a position where a corresponding second part is highly probable to be present; and
an association unit that associates parts of the same subject, among the first part and the second part detected by the detection unit, based on the vectors.

9. The image processing apparatus according to claim 8,
wherein the association unit associates the first part, for which is detected a vector, among the vectors, that as an ending point within a search area set on the second part, with the second part.

10. The image processing apparatus according to claim 8,
wherein the one or more processors further function as:
an estimation unit that estimates a movement direction of the specific subject,
wherein the association unit associates the first part for which is detected a vector, among the vectors having ending points within a search area set on the second part, which is consistent with the estimated movement direction, with the second part.

11. The image processing apparatus according to claim 1,
wherein the detection unit executes detection of the first part and detection of the second part separately.

12. The image processing apparatus according to claim 1,
wherein the detection unit detects the first part and the second part using a neural network in which is set dictionary data containing a combination of a type of the specific subject and a part to be detected.

13. The image processing apparatus according to claim 1,
wherein the specific subject is a human or an animal.

14. The image processing apparatus according to claim 13,
wherein the first part is a trunk and the second part is a head.

15. An image processing method executed by an image processing apparatus, the image processing method comprising:
detecting a first part and a second part of a specific subject from an image;
estimating a movement direction of the specific subject; and
based on the estimated movement direction, associating parts of the same subject, among the first part and the second part detected in the detecting.

16. An image processing method executed by an image processing apparatus, the image processing method comprising:
detecting a first part and a second part of a specific subject from an image, wherein a detection result for the first part includes vectors indicating a position where a corresponding second part is highly probable to be present; and
associating parts of the same subject, among the first part and the second part detected in the detecting, based on the vectors.

17. A non-transitory computer-readable medium that stores a program, which when executed by a computer, causes the computer to function as an image processing apparatus comprising:
a detection unit that detects a first part and a second part of a specific subject from an image;
an estimation unit that estimates a movement direction of the specific subject; and
an association unit that, based on the estimated movement direction, associates parts of the same subject, among the first part and the second part detected by the detection unit.

18. A non-transitory computer-readable medium that stores a program, which when executed by a computer, causes the computer to function as an image processing apparatus comprising:
a detection unit that detects a first part and a second part of a specific subject from an image, wherein a detection result for the first part includes vectors indicating a position where a corresponding second part is highly probable to be present; and
an association unit that associates parts of the same subject, among the first part and the second part detected by the detection unit, based on the vectors.
